(19) United States
(12) Patent Application Publication
(10) Pub. No.: US 2008/0312950 A1
(43) Pub. Date: Dec. 18, 2008

(54) Tracking Frequent Flyer Miles

(75) Inventors: James Testa, Palo Alto, CA (US); Nina Holly, Palo Alto, CA (US)

Correspondence Address: AERENDE, INC., PMB 518, 555 BRYANT ST., PALO ALTO, CA, 94301, US

(73) Assignee: WEBSITES BY JOVE, LLC, A CALIFORNIA LLC, Palo Alto, CA (US)

(21) Appl. No.: 12/186,073

(22) Filed: Aug. 5, 2008

(51) Int. Cl. G06Q 99/00

(52) U.S. Cl. 705/1

(57) ABSTRACT

Inter alia, methods, and means for tracking frequent flyer miles. One embodiment identifies a user database which has a one to many relationship to an accommodations database which contains flights the user has taken along with the corresponding distance traveled in that flight. The distance traveled corresponds to the frequent flyer miles that have been earned for that flight. There is further a vendors database which contains the vendors with which the accommodation occurred with, along with an accommodations_vendors database which indicates which accommodation corresponds to which vendor. With these databases, on a per user basis, the number of frequent flyer miles per user per vendor can be determined. Two other databases allow the determination of the number of frequent flyer miles that can be redeemed for a given vendor based on the number of frequent flyer miles earned on the vendor partners of a given vendor. These two databases are the partners database and the partners_vendors database. Thus the tracking of frequent flyer miles allows the user to determine a) the number of frequent flyer miles that can be redeemed with one vendor based on the trips taken with that vendor, and b) the total number of frequent flyer miles redeemable with a given vendor based on the number of frequent flyer miles earned with all the vendors that are partners with the given vendor.

### CROSS-REFERENCE TO RELATED APPLICATIONS

Patent Application: US 20010037243—System and method for redeeming frequent flyer miles.
U.S. Pat. No. 6,944,652—Method and apparatus for providing frequent flyer miles and incentives for timely interaction with a time records system
U.S. Pat. No. 6,379,247—Method and system for awarding frequent flyer miles for casino table games

### TECHNICAL FIELD

One embodiment of the invention especially relates to tracking a passenger's airline frequent flyer miles on a network, such as the Internet; and more particularly, one embodiment relates to deriving the sum of a traveler's frequent flyer miles for a given airline from the sum of the frequent flyer miles from the airline's alliance partners added to the sum of the frequent flyer miles for that airline.

### BACKGROUND

Many commercial airlines provide passengers with incentives to fly more frequently in the form of frequent flyer miles. Passengers can use frequent flyer miles for free tickets for future flights or for upgrades traveling class (from coach to first class say) of tickets for flights already purchased. Passengers earn miles by becoming a member of an airline's frequent flyer program and buying tickets for flights, but passengers can also earn frequent flyer miles through other sources, such as hotel stays, credit card usage, and consumer purchases. The airlines' frequent flyer programs require the passenger to accumulate a certain number of frequent flyer miles, which the passenger can redeem for free airline tickets, ticket upgrades, or merchandise. In some cases, the miles expire if the passenger does not redeem them before a certain date, or if no purchases for tickets for flights has been made during a period of time.

A passenger can redeem frequent flyer miles earned with one airline for tickets with another airline, provided that an alliance exists between the two airlines. However, a major obstacle to redeeming frequent flyer miles for a given airline is determining the total of that passenger's frequent flyer miles, and the airlines where the miles can be redeemed. This problem arises because of the number of airlines (several thousand airlines worldwide), and the increasingly complex and continuously changing network of frequent flyer program partnerships among airlines. Passengers are thus faced with the need to track their frequent flyer miles on all airlines partnered with the airline where the passenger initially earned the frequent flyer miles. This necessitates tracking all frequent flyer program partners of an airline (or multiple airlines), updating the list of partnerships as it changes, updating the frequent flyer mile requirements for each airline, and keeping track of miles that may expire.

The lack of a centralized frequent flyer mile tracking system causes passengers to accidentally forfeit or not use frequent flyer miles to which they are otherwise entitled. Thus, a need exists for a central tracking system to account for the constantly changing airlines' frequent flyer program partnerships, redemption rules, and mileage expiration dates.

### PRIOR ART

One known approach for tracking frequent flyer miles is described in W. Graeme Rouston, et al, “System and method for redeeming frequent flyer miles”, US Patent Application 20010037243. This application has as its first claim “A method of redeeming airline frequent flyer miles by an employee of an employer, comprising: accruing a number of frequent flyer miles; redeeming a selected number of the frequent flyer miles to receive a benefit in connection with a business-related airline ticket purchase; and receiving a corresponding incentive.” In this method, the frequent flyer mile tracking system only tracks miles for the employees of a certain employer, and pools the frequent flyer miles earned by the employees on business travel to be redeemed for future business-related travel. Hence this invention only covers a frequent flyer mile tracking system for a limited group, the employees of a certain employer, but not any passenger who may or may not be traveling on business.

Another known approach related to frequent flyer miles is described in Walker, Jay S. and Jorasch, James A., “Method and system for awarding frequent flyer miles for casino table games”, U.S. Pat. No. 6,379,247, awarded Apr. 30, 2002. This patent has as its first claim “A system for rewarding play at a gaming table having a station for a dealer and a plurality of stations for a respective plurality of players, the system comprising: a plurality of reward counters, each reward counter associated with a respective one of said plurality of players and including: an input device for receiving input from said dealer to register a complimentary reward for said respective player . . . .” This is a limitation, as the system is designed for the awarding of frequent flyer miles based on a customer's casino play.

Another limitation of the system is that the awarded frequent flyer miles are tracked by a reward counter, with input by a casino dealer. This invention is limited, because it only covers a method of tracking frequent flyer miles awarded by a casino dealer, on a reward counter limited to tracking the casino's frequent flyer awards.

Another known approach is described by Finch, TI; Curtis L., et al “Method and apparatus for providing frequent flyer miles and incentives for timely interaction with a time records system” in U.S. Pat. No. 6,944,652. The first claim of this patent describes a time keeping and expense tracking system that “determine[s] and store[s] approval performance of the manager including timeliness of manager response . . . and further determines whether an employee manager has approved employee time entries according to a specified process and should receive a reward . . . ”, This is a limitation, since the invention describes a method of awarding frequent flyer miles as a reward for employee managers who use a time keeping and expense system in a timely manner. The invention does not address tracking frequent flyer miles for any passengers, but only for an incentive program limited to a particular employer and its managers.

### OBJECTS AND ADVANTAGES

Tracking frequent flyer miles has the following main advantages:
1) email confirmations from airlines and vendors are parsed and the distance traveled for that flight is entered into the customer's frequent flyer database for that airline,
2) a database table contains all of the current frequent flyer program partners for the airline used by the customer in 1),
3) using the partners found in 2), the frequent flyer miles for all of the partners is updated with the distance traveled in 1)
4) on the customer's frequent flyer miles summary page, selecting an airline provides the sum of the frequent flyer miles for the selected airline and all of the airline's partners,
5) for the selected airline, the summary page displays the number of frequent flyer miles required for a coach ticket or upgrade to first class,
6) when the customer redeems any frequent flyer miles, the number of frequent flyer miles redeemed is subtracted from a) the total number of frequent flyer miles for the airline where the passenger redeemed the frequent flyer miles, and b) from the frequent flyer miles of all of the alliance partners for that airline.
7) the frequent flyer miles are tracked on a website so that a customer can access his frequent flyer miles account information wherever he has Internet access,
8) the vendor information is stored at the website database including the frequent flyer number, allowing the easy access for the user to the frequent flyer number which is needed to redeem the frequent flyer miles,
9) the frequent flyer miles stored in the website database are marked with an expiration date, as per each airline's rules, and if the frequent flyer miles have expired, those miles are not added to the frequent flyer miles total,
10) the customer is notified by the database whenever any of his frequent flyer miles are about to expire.

### SUMMARY

Inter alia, methods, and means for tracking frequent flyer miles, the airline partnerships where the frequent flyer miles may be redeemed, and tracking the expiration dates of frequent flyer miles. In one embodiment, the method and means are carried out over a computer network, such as the Internet.
The system includes a computer database of a plurality of customers' frequent flyer miles, and the allocation of the frequent flyer miles among the airlines where each customer earned the miles. The system includes another database listing the frequent flyer program partnerships for each airline. When a customer accesses the computer database showing her accumulated frequent flyer miles, the system will display all of the partner airlines where she may redeem her frequent flyer miles.
The system includes an additional computer database containing the dates when the customer earned the frequent flyer miles, and a database containing the frequent flyer miles expiration dates set by each airline. Only frequent flyer miles that have not expired will be added to the sum total of frequent flyer miles. In one illustrative embodiment, the customer will be notified upon accessing the system when her miles are set to expire. Alternatively, the customer will be notified of imminent mileage expiration via an automated electronic communication from the system, for example an e-mail or text message.
In one illustrative embodiment, the system can be accessed by customers over a computer network, such as the Internet. Alternatively, customers can access the system over a cellular or paging network, as via an electronic mobile device.

### BRIEF DESCRIPTION OF THE DRAWINGS

The appended claims set forth the features of tracking frequent flyer miles with particularity. Tracking frequent flyer miles, together with its advantages, may be best understood from the following detailed description taken in conjunction with the accompanying drawings of which:

FIG. 1 illustrates the connections of the user, airline, and airline frequent flyer program partner databases. From the user database to the accommodation database there is a one-to-many connection; that is, each user's database is linked to a personalized list of accommodations which store the individual flights the user has purchased tickets for. From the accommodation database to the vendor database there is also a one-to-many connection, that is, facilitated by an accommodations_vendors join table. The accommodations_vendors database indicates which vendor the accommodation used. Finally there is a partner database which is linked to he vendor database via a partner vendor join table, which indicates which partners are associated with which vendors.

FIG. 2 illustrates the interconnections between the page views of the frequent flyer information for one user. The user can see an overview of his miles in the MyMiles view that lists the airlines selected by that user. The MyMiles view also shows the number of frequent flyer miles the user has with each airline. From the MyMiles page, the user can access two other pages, each page contains additional mileage information. One of the pages shows the user his Locations and Miles, specifically the number of miles needed to upgrade the user's ticket or obtain a new ticket for coach, depending on the location to which the user wishes to travel. The second page, Partners, shows the frequent flyer program partner airlines associated with each of the airlines on the user's list.

FIG. 3 illustrates the Locations and Miles page, which has a button to allow for upgrading the user's ticket and a button for obtaining a new ticket with the user's frequent flyer miles. Upon upgrading his ticket or redeeming a ticket for frequent flyer miles, the user clicks the appropriate button, which subtracts the correct number of frequent flyer miles from the user's total available frequent flyer miles.

FIG. 4 illustrates the Partners page, which lists the airlines that are frequent flyer program partners for each airline on the user's list. The Partners page also lists each partner's level of frequent flyer mile sharing, and award table. The award table is shown on the Locations and Miles page and indicates the number of frequent flyer miles needed to either upgrade a ticket from coach to first class as well as to purchase a ticket, based on the starting location of the flight and the destination.

### DETAILED DESCRIPTION

Inter alia, methods, means and apparatus are disclosed for tracking frequent flyer miles. One embodiment of tracking frequent flyer miles especially relates to communications and computer systems and the internet.

Embodiments described herein include various elements and limitations, with no one element or limitation contemplated as being a critical element or limitation. Each of the claims individually recites an aspect of the tracking frequent flyer miles in its entirety. Moreover, some embodiments described may include, but are not limited to, inter alia, systems, networks, integrated circuit chips, embedded processors, ASICs, methods and computer-readable medium containing instructions. The embodiments described hereinafter embody various aspects and configurations within the scope and spirit of the tracking frequent flyer miles, with the Figs illustrating exemplary and non-limiting configurations.

The term “system” is used generally herein to describe any number of components, elements, systems, devices, packet switch elements, packet switches, routers, networks, computer and/or communication devices or mechanisms, or combinations of components thereof. The term “computer” is used generically herein to describe any number of computers, including, but not limited to personal computers, embedded processing elements and systems, control logic, ASICs, chips, workstations, mainframes, etc. The term “processing element” is used generically herein to describe any type of processing mechanism or devices, such as a processor, ASIC, field programmable gate array, computer, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the Figs, including, but not limited to any block and flow diagrams and message sequence charts, may be performed in the same or in a different serial or parallel ordering and/or by different components and/or processes, threads, etc., and/or over different connections and be combined with other functions in other embodiments n keeping within the scope and spirit of the tracking frequent flyer miles. Furthermore, the term “identify” is used generically to describe any manner or mechanism for directly or indirectly ascertaining something, which may include but is not limited to receiving, retrieving ROM memory, determining, defining, calculating, generating, etc.

Moreover, the terms “network” and “communications mechanism” are used generically herein to describe one or more networks, communications mediums or communications systems, including, but not limited to the Internet, private or public telephone, cellular, wireless, satellite, cable, local area, metropolitan area and/or wide area networks, a cable electrical connection, bus, etc., and internal communications mechanisms such as message passing, inter-process communications, shared memory, etc. The term “message” I used generically herein to describe a piece of information which may or may not be, but is typically communicated via one or more communication mechanisms of any type.

The term “storage mechanism” includes any type of memory, storage device or other mechanism for maintaining instructions or data in any format. “Computer readable medium” is an extensible term including any memory, storage device, storage mechanism, and other storage and signaling mechanisms including interfaces and devices such as network interface cards and buffers therein, a well as any communications devices and signals received and transmitted, and other current and evolving technologies that a computerized system can interpret, receive, and/or transmit. The term “memory” includes any random access memory (RAM), read only memory (ROM), flash memory, integrated circuits, and/or other memory components or elements. The term “storage device” includes any solid state storage media, disk drivers, diskettes, networked services, tape drives, and other storage devices. Memories and storage devices may store computer-executable instructions to be executed by a processing element and/or control logic, and data which is manipulated by a processing element and/or control logic. The term “data structure” is an extensible term referring to any data element, variable, data structure, database, and/or one or more organizational schemes that can be applied to data to facilitate interpreting the data or performing operations on it, such as, but not limited to memory locations or devices, sets, queues, trees, heaps, lists, linked lists, arrays, tables, pointers, etc. A data structure is typically maintained in a storage mechanism. The terms “pointer” and “link” are used generically herein to identify some mechanism for referencing or identifying another element, component, or other entity, and these may include, but are not limited to a reference to a memory or other storage mechanism or location therein, an index in a data structure, a value, etc. The term “associate memory” is an extensible term, and refers to all types of known or future developed associative memories, including, but not limited to binary and ternary content addressable memories, hash tables, TRIE and other data structures, etc. Additionally, the term “associative memory unit” may include, but it not limited to one or more associative memory devices or parts thereof, including, but not limited to regions, segments, banks, pages, blocks, sets of entries, etc.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the phrase “means for xxx” typically includes computer-readable medium containing computer-executable instructions for performing xxx.

In addition, the terms “first”, “second”, etc. are typically used herein to denote different units (e.g., a first element, a second element). The use of these terms herein does not necessarily connote an ordering such as one unit or event occurring or coming before another, but rather provides a mechanism to distinguish between particular units. Additionally, the use of the singular tense of a noun I non-limiting, with its use typically including one or more of the particular thing rather than just one (e.g., the use of the word “memory” typically refers to one or more memories without having to specify “memory or memories” or “one or more memories” or “at least one memory”, etc.). Moreover, the phrases “based on x” and “in response to x” are used to indicate a minimum set of items x from which something is derived or caused, wherein “x” is extensible and does not necessarily describe a complete list of items on which the operations is performed, etc. Additionally, the phrase “coupled to” is used to indicate some level of direct or indirect connections between two elements or devices, with the coupling device or devices modifying or not modifying the coupled signal or communicated information. The term “subset” is used to indicate a group of all or less than all of the elements of a set. The term “or” is used herein to identify a selection of one or more, including all, of the conjunctive items.

### PREFERRED EMBODIMENT

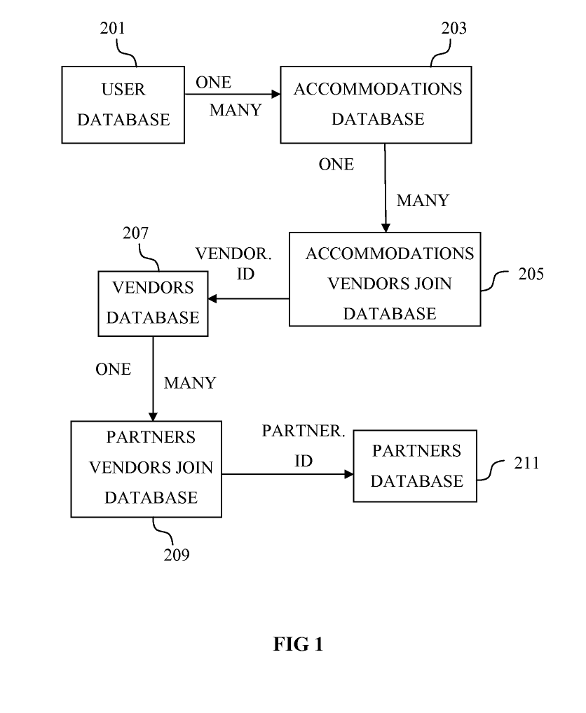

One embodiment that tracks frequent flyer miles consists of six databases, a user database, an accommodations database, a vendor database that includes airlines, an accommodations_vendors database, a frequent flyer program partners database, and a partners_vendors database. FIG. 1 illustrates one embodiment consisting of a user database, 201, an accommodations database, 203, a vendor database, 207, an accommodations_vendors database, 205, a partners database, 211, and a partners_vendors database, 209. There is a one to many relationship between the user database and the accommodations database, meaning that each user in the user database can have many accommodations in the accommodations database. The user database has a unique user ID for each user, and each accommodation has a unique accommodations ID. The accommodations_vendors database entries contain an accommodation ID and a vendor ID. The accommodations_vendors database is a “join table” in Structured Query Language (SQL) terminology meaning that the accommodations_vendors database joins a row in the accommodations database with a row in the vendors database. Similarly, the vendor database contains a unique vendor ID for each vendor. The partners_vendors database entries contain a partner ID and a vendor ID. The partners_vendors database is a “join table” in SQL terminology, meaning that the partners database joins airline ID data and an associated partner ID per row. The partner ID is the vendor ID of a partner airline also listed in the vendor table.

Each entry in the accommodations database tracks each user's distance traveled for a given flight, car, etc. in miles or km. Also stored in the vendor database is the total distance traveled on all partners of a given vendor. The total distance traveled is updated by searching for all of the accommodations for a given vendor, and summing the distance of each accommodation. The vendor database also contains the frequent flyer miles expiration time in months, indicating how long a frequent flyer account needs to be inactive (i.e.: with no new miles added) before the frequent flyer miles expire. The “ff miles_expire_entend” field indicates if the usability of frequent flyer miles can be extended if the user adds more frequent flyer miles, or if the miles expire after a set amount of time indicated by the “ff_miles_expiration_time.” The user can also redeem frequent flyer miles for seat upgrades (i.e. from coach to first class) or to purchase new flight tickets. The vendor database also keeps track of the number of miles that have been redeemed and subtracts this amount from the total number of miles in the accommodations, to generate a total number of frequent flyer miles that are available to be redeemed.

The vendor database also includes the number of frequent flyer miles needed to get a seat upgrade to first class or to purchase a coach ticket for many locations including but not limited to the United States, South America, Europe, India, and Africa. The vendor database also includes the total distance traveled on a given vendor by any one user.

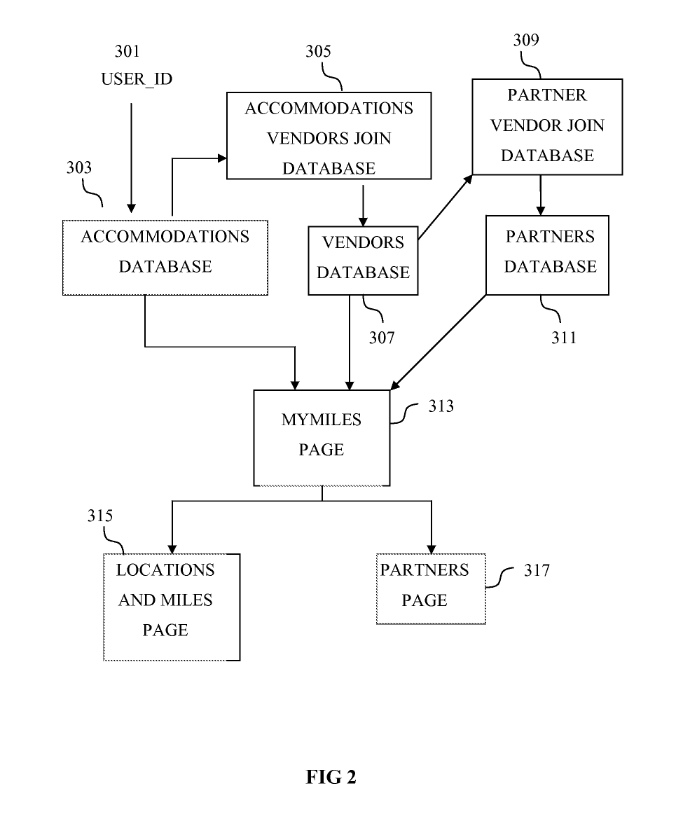

FIG. 2 illustrates the interconnections between the page views that display the frequent flyer information. A user ID, 301, is provided to select all of the accommodations for that user from the accommodations database, 303. Each accommodation corresponds to an entry in the accommodations_vendors join database, 305, which indicates which vendor in the vendors database, 307, was used for the selected accommodation. This gives a list of accommodations with an associated vendor. Each vendor in that list is used to index the partners_vendors join database, 309, to provide a list of vendor partners from the partners database, 311, for that vendor. The accommodations list is pruned by removing any accommodations whose frequent flyer miles have expired. This is determined by using the FF-Miles_expiration_date and ff_miles_expire_extend fields in the associated vendor entry in the vendor database for each accommodation. Ff_miles_expire_extend when true allows frequent flyer miles to not expire if there have been intervening flights between the flight in question and the current time. If the time between the accommodation's start_date and the current date is greater than the ff_miles_expiration_time and there are no other accommodations within the time period of ff_miles_expiration_time, and ff_miles_expire_extend is false, then the frequent flyer miles will not be added to the total frequent flyer miles stored in total_distance.

The vendors can also be selected per user ID, which gives a list of vendors. For each vendor, the user's accommodations are checked to see if that accommodation used that vendor. If it did, then the distance is added to the total distance for that vendor. Once the list of vendors has been gone through, the total distance frequent flyer miles, has been summed for each vendor. This total is listed on the MyMiles web page.

Per vendor, the list of vendor partners is stepped through and the total distance for each partner is added to the total_partners_distance for each vendor. The total_partners_distance is added to the total distance for that vendor to get the total frequent flyer miles for that vendor. The MyMiles page has a link to the Locations_and_miles page which lists the number of miles per location needed to upgrade from coach to first class as well as the number of miles per location needed to purchase an airline ticket.

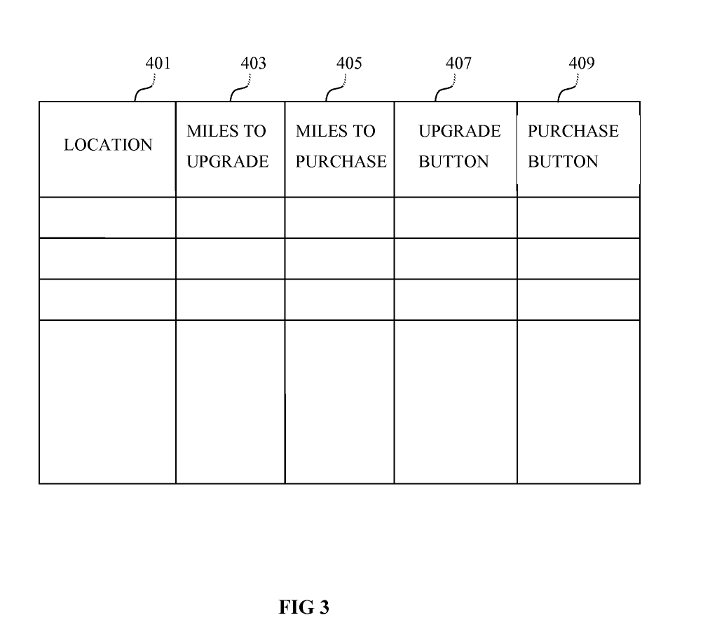

FIG. 3 illustrates the Locations_and_Miles page which has a list of locations, 401, frequent flyer miles needed to upgrade a ticket from coach to first class for these locations, 403, frequent flyer miles needed to purchase a ticket to these locations, 405, and a button per location to update the miles_upgrade field in the vendors database, 407, as well as another button to update the miles_purchase field in the vendors database, 409. The miles_upgrade button is used when upgrading a ticket, to add the number of miles redeemed to upgrade the flight ticket, to the miles_upgrade field in the vendor database. The miles_purchased button is used when purchasing a ticket, to add the number of miles redeemed to purchase the flight ticket, to the miles_purchased field in the vendor database. The miles_upgrade field is subtracted from the total_distance field in the vendors database, when presenting the total number of frequent flyer miles available for redemption. The miles_purchase field is also subtracted from the total_distance field in the vendors database, when presenting the total number of frequent flyer miles available for redemption. The Locations and Miles page also has a link to the Partners page

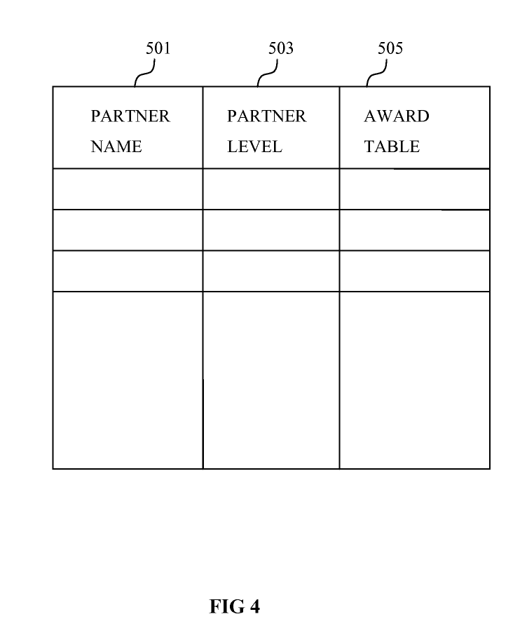

FIG. 4 illustrates the Partners page that contains a table per vendor indicating the vendors partner's names, 501, their partner level, 503, and the award table, 505, applicable for that partner in redeeming frequent flyer miles.

### ALTERNATIVE EMBODIMENTS

An alternative embodiment could be to display the frequent flyer miles, rewards tables, partners, etc. in a different arrangement of the page views. For example instead of displaying the partners on a separate page, the partners could be stored in a scrollable window on the MyMiles page.

### CONCLUSION, RAMIFICATIONS AND SCOPE

In view of the many possible embodiments to which the principles of the tracking frequent flyer miles may be applied, one may appreciate that the embodiments and aspects thereof described herein with respect to the drawings/figures are only illustrative and should not be taken as limiting the scope of tracking frequent flyer miles. For example and as would be apparent to one skilled in the art, there exist many different approaches to displaying the frequent flyer miles, the partners, and the reward tables.

Tracking frequent flyer miles as described herein, contemplates all such embodiments as may come within the scope of the following claims and equivalents thereof.

What is claimed is:

1. In combination:
(a) A means for tracking frequent flyer program miles for an individual traveler, comprising a unique user account, a list of activities the traveler has taken each with an associated number of frequent flyer miles accumulated by the traveler, and
(b) the list of vendors with one of these vendors corresponding to the vendor used for the activity,
(c) a list indicating which activities were carried out with which vendor and,
(d) summing the number of frequent flyer miles for each activity for that vendor per user determines the total number of frequent flyer miles per vendor per user.

2. The frequent flyer tracking program according to claim 1, further including
(a) a table indicating which vendors have which partners,
(b) means for determining the total number of frequent flyer miles for all of the partners of that vendor for that said user.

4. The frequent flyer tracking program according to claim 1, further including means whereby an individual traveler can electronically store and view the number of frequent flyer miles accumulated, the travel vendor partners where the frequent flyer miles may be used for upgrades or free services, and the number of frequent flyer miles required by each partner to redeem said upgrades or free services.

5. The frequent flyer tracking program according to claim 1, with further means for displaying the frequent flyer information on an electronic device, such as a computer monitor, cellular telephone, or personal digital assistant, by means of a connection to the Internet or another data network, such as a cellular network.

6. The frequent flyer tracking program according to claim 1, further including a means for adding and subtracting miles from the traveler's account based on the traveler's itineraries or direct data input.

7. The frequent flyer tracking program according to claim 1, further including a means to subtract the number of frequent flyer miles redeemed due to upgrading a airline ticket for a flight or subtracting the number of frequent flyer miles redeemed due to purchasing an airline ticket for a flight.

8. The frequent flyer tracking program according to claim 1, further including a means to determine that frequent flyer miles have expired based solely on the age of the frequent flyer miles, or on the age of the frequent flyer miles and the lack of activity in the user's frequent flyer account with that vendor.

9. A machine for calculating the total number of frequent flyer miles per user comprising:
(a) A list of vendors that are used by a user for activities,
(b) a list indicating which activities were carried out with which vendor,
(c) a list of activities per user,
(d) a program for determining the total number of frequent flyer miles per vendor per user by selecting each vendor for that user and determining which activities were performed by that user and that vendor, and summing the number of frequent flyer miles for that activity for that vendor and placing that total in the vendor entry in the vendor list.

10. The frequent flyer tracking program according to claim 9, further including
(a) a table indicating which vendors have which partners,
(b) means for determining the total number of frequent flyer miles for all of the partners of that vendor for that said user.

11. The frequent flyer tracking program according to claim 9, further including means whereby an individual traveler can electronically store and view the number of frequent flyer miles accumulated, the travel vendor partners where the frequent flyer miles may be used for upgrades or free services, and the number of frequent flyer miles required by each partner to redeem said upgrades or free services.

12. The frequent flyer tracking program according to claim 9, with further means for displaying the frequent flyer information on an electronic device, such as a computer monitor, cellular telephone, or personal digital assistant, by means of a connection to the Internet or another data network, such as a cellular network.

13. The frequent flyer tracking program according to claim 9, further including a means for adding and subtracting miles from the traveler's account based on the traveler's itineraries or direct data input.

14. The frequent flyer tracking program according to claim 9, further including a means to subtract the number of frequent flyer miles redeemed due to upgrading a airline ticket for a flight or subtracting the number of frequent flyer miles redeemed due to purchasing an airline ticket for a flight.

15. The frequent flyer tracking program according to claim 9, further including a means to determine that frequent flyer miles have expired based solely on the age of the frequent flyer miles, or on the age of the frequent flyer miles and the lack of activity in the user's frequent flyer account with that vendor.
